(19) United States
(12) Patent Application Publication
(10) Pub. No.: US 2004/0209049 A1
(43) Pub. Date: Oct. 21, 2004

(54) Laser marking in retroreflective security laminate

(76) Inventor: Marco Bak, AK's-Gravenzande (NL)

Correspondence Address: STALLMAN & POLLOCK LLP, Suite 290, 121 Spear Street, San Francisco, CA, 94105, US

(21) Appl. No.: 10/418,033

(22) Filed: Apr. 17, 2003

(51) Int. Cl. B32B 3/00

(52) U.S. Cl. 428/172

(57) ABSTRACT

An image including an array of image elements is written in a security laminate. The laminate includes a binder layer including an array of micro spheres surmounting a reflective layer. Image elements are written by delivering a beam of electromagnetic radiation at a predetermined incidence angle on the laminate. Portions of the beam are concentrated by one or more of the micro spheres onto the reflective layer. The reflective layer is damaged in areas on which the laser radiation is concentrated. Each damaged area provides one element of the image. The reflective layer is formed into a plurality of concave reflectors, one for each micro sphere. The arrangement of the micro spheres, the concave reflectors and the damaged areas provides that the image is only clearly visible at about the angle of incidence at which the radiation beam is delivered. Two different images can be written into the reflective layer, with one image being visible at only one angle, and the other image being visible at only another angle.

### TECHNICAL FIELD OF THE INVENTION

The present invention relates generally to laser marking. It relates in particular laser marking a halftone image in a selectively retroreflective security laminate.

### DISCUSSION OF BACKGROUND ART

U.S. Pat. No. 5,169,707 discloses a structure and manufacturing method of a selectively retroreflective security laminate useful for applying to documents such as identification cards, driver's licenses, passports, credit cards and the like for authentication purposes. Such a security laminate is available from the 3M Corporation of St. Paul, Minn. under the brand name Confirm®. The laminate includes an identifying image that is not readily visible under ambient light conditions, but is clearly visible under directed lighting that shows the image against a bright-reflected background. This image is added to the laminate at the time of manufacture of the laminate in bulk, in commercially viable quantities, and, accordingly, is the same on any particular batch of documents.

FIG. 1 schematically illustrates a cross-section of a portion of one example 10 of the prior-art security laminate disclosed in the '707 patent. The security laminate includes a protective layer 12 in which an image is printed or impressed. The image, for example, may provide an authentication feature similar to a watermark or the like. Portions of the image are represented by rectangles 14.

A layer 16 of a binder material includes a two-dimensional array of micro spheres 18 having a refractive index higher than that of the binder material. Only one dimension of the array is shown, for convenience of illustration. Beneath the binder layer and micro spheres is a layer 20 of a reflective material. Layer 20 is formed into an array of concave (with respect to the micro spheres) reflective elements 22, with one reflective element 22 being provided for each micro sphere in the array. Beneath the layer of reflective material is an adhesive layer 24 protected by a releasable backing layer 26.

The micro spheres and the reflective layer are arranged such that when viewed under ambient lighting conditions the image represented by portions 14 thereof is scarcely visible, but when viewed by collimated light directed normal to the laminate the image is clearly visible.

As the image is added at the time the laminate is manufactured, any document protected by that laminate will include that image. It would be useful to be able to provide at least one additional image to serve as an additional security feature, an identification feature, a date code or the like to the laminate after it is manufactured, or when it is already applied to a document.

### SUMMARY OF THE INVENTION

The present invention is directed to a method of writing an image in a laminate. The image includes an array of image elements. The laminate includes a binder layer surmounting a reflective layer, and the binder layer includes an array of micro spheres. The image writing method comprises delivering a beam of electromagnetic radiation onto the laminate at a predetermined incidence angle and at a position thereon such that the beam is concentrated by at least one of the micro spheres onto the reflective layer. The radiation beam has a power sufficient that the reflective layer is damaged in an area thereof on which the radiation beam is concentrated. The damaged area provides one element of the image.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a cross-section view schematically illustrating a prior-art security laminate including an array of micro spheres and a reflective layer formed into an array of concave reflective elements corresponding to the micro sphere array.

FIG. 2 is a cross-section view schematically illustrating one embodiment of the method of the present invention for forming an element of an image in the reflective layer of the laminate of FIG. 1.

FIG. 3 schematically illustrates a laser, a scanning mirror and a lens arranged to form a plurality of image elements, one element at a time, according to the method of FIG. 2 in the array of reflective elements of the reflective layer of the laminate of FIG. 1.

FIG. 4 is a cross-section view schematically illustrating another embodiment of the method of the present invention for simultaneously forming a plurality of elements of an image in the reflective layer of the laminate of FIG. 1.

FIG. 5 schematically illustrates a laser, and a beam expander arranged to form a plurality of image elements according to the method of FIG. 4 in the reflective layer of the laminate of FIG. 1.

### DETAILED DESCRIPTION OF THE INVENTION

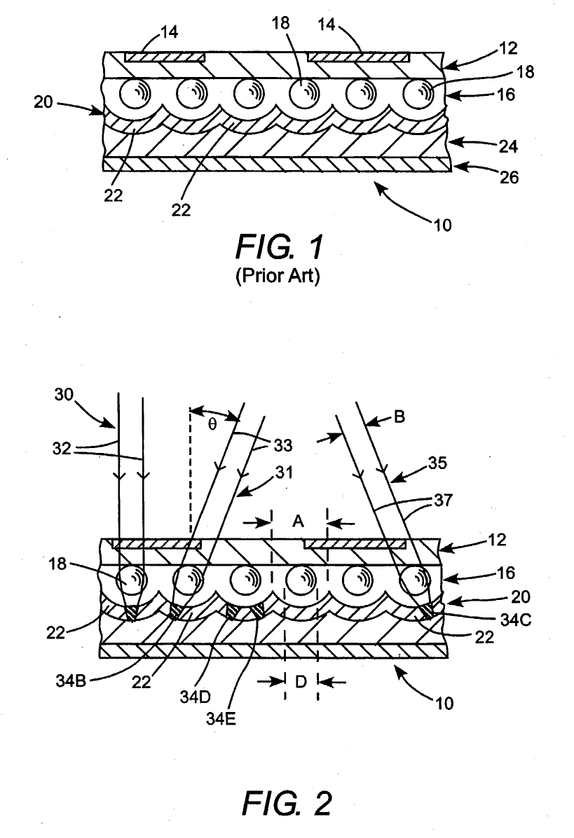

Referring now to the drawings, wherein like features are designated by like reference numerals, FIG. 2 schematically illustrates implementations of a method in accordance with the present invention for forming an image element in a reflective element of the above-discussed prior-art laminate of FIG. 1. In one implementation of the method, a beam 30 (defined by rays 32 thereof) of electromagnetic radiation having a diameter B is directed through protective layer 12 of laminate 10 onto a micro sphere 18 in the layer of binder material. It should be noted here that the while the term “array” is applied to micro spheres 18 of layer 16 in this description and the claims appended hereto, this should not be construed as meaning that the micro spheres are exactly equally spaced. There can be some difference in spacing of the micro spheres, for example, about the diameter of a micro sphere or less. In commercially available laminate 10, micro spheres typically have a diameter between about 40 and 200 micrometers (μm). The diameter of the micro spheres in any sample may also not be exactly equal.

The micro sphere 18 concentrates the beam onto a reflective element 22 of reflective layer 20. Reflective elements 22 are designated here as having a diameter A. The wavelength of the radiation is preferably selected such that it is strongly absorbed by the material of layer 20. The absorbed radiation damages the reflective layer at the position thereon where the radiation is absorbed, resulting in a damaged area 34 that is not reflective for the visible wavelengths of light under which the laminate will be viewed. The damaged area 34 can then form the element of an array (not shown in FIG. 2) of such elements. Preferably, there is only one damaged area or image element of any given image in a reflective element 22. A damaged area (image element) may have a diameter from about a few tenths of a percent of the diameter of a reflective element 22 up to about fifty percent of the diameter of a reflective element 22 or greater. The diameter of the damaged area can be controlled by controlling the power in beam 30. This is useful, for example, for forming areas (elements) of different size to control half-tone levels in an image.

In one preferred embodiment of the inventive method, radiation in beam 30 is in the form of a pulse of radiation, such as a pulse of laser radiation. Delivery of laser radiation in a pulsed form and concentrating the radiation can provide that a relatively small amount of energy in a pulse can provide a high peak power in the reflective layer for causing damage to the layer. One pulse can be delivered for forming each image element.

The laser wavelength is preferably selected such that it is transmitted by the material of layer 12 of the laminate, by portions 14 of the security feature of the laminate, and also by the material of micro spheres 18 and the binder layer material. One preferred wavelength range is between about 300 and 450 nanometers (nm) is preferred. A particularly preferred wavelength is 355 nm. This wavelength is the wavelength, of laser radiation pulses delivered by a frequency-tripled (third-harmonic) neodymium-doped yttrium vanadate (Nd:YVO₄) laser. It has been found that at this wavelength a pulse energy of a little as a few micro joules (μJ) delivered in a pulse having a duration of about twenty nanoseconds (ns) is sufficient to form an image element 34. Such low energy pulses are deliverable at a repetition rate up to about about fifty kilohertz (KHz). This provides that a two-hundred-fifty thousand element (pixel) image can be written in about five seconds at one pulse per element.

The fundamental wavelength (1064 nm) radiation of Nd:YVO₄ has been found to damage micro spheres 18; second-harmonic wavelength (532 nm) wavelength radiation of Nd:YVO₄ is not efficiently absorbed by reflective layer 20; and fourth-harmonic wavelength (266 nm) wavelength radiation of Nd:YVO₄ is absorbed by layer 12.

It should be noted here that the comments concerning a preferred laser-radiation wavelength for writing are directed to materials of commercially available laminate 10, wherein reflective layer 20 is formed from a high refractive index dielectric material. However, from the description of the present invention presented herein, one skilled in the laminate art may develop a laminate having the construction of laminate 10, but using materials for which another laser radiation wavelength may be more suitable. Accordingly, the invention should not be construed as being limited by a particular radiation wavelength of beam 30.

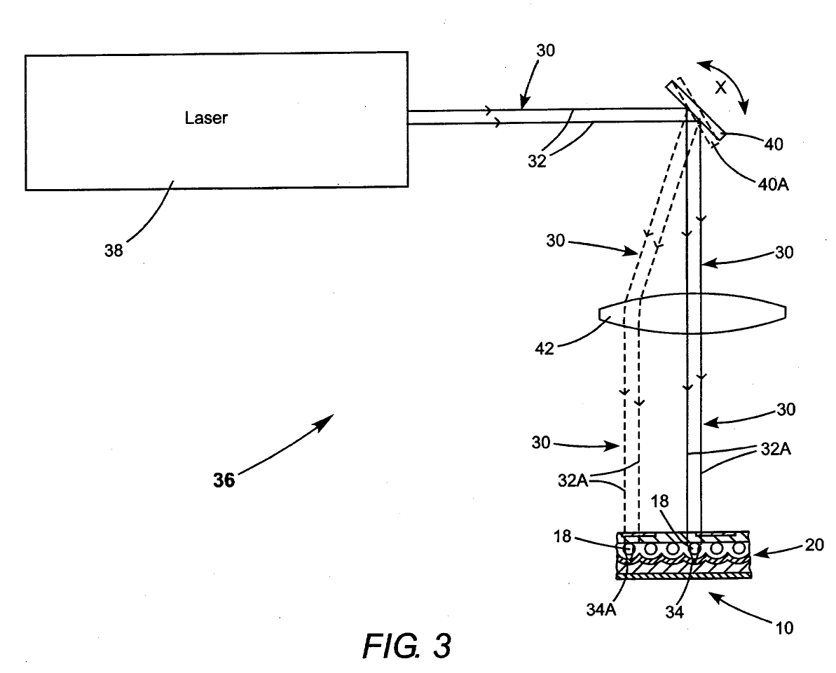

FIG. 3 schematically illustrates one example of an optical arrangement 36 for forming an array of image elements in laminate 10. Here, a laser 38 delivers collimated beam 30 to a tiltable mirror 40. Mirror 40 is tiltable in two mutually perpendicular axes for directing the beam, but is shown, for convenience of illustration, as tilting in only one axis, as indicated by double arrow A. Those skilled in the art will recognize that a combination of two tiltable mirrors may also be used for directing the beam.

The beam is directed by mirror 40 through a positive lens 42, here represented for convenience of illustration as a single element. The beam is then normally incident (incident at about zero degrees) laminate 10 covering one micro sphere 18, and forms an image element 34 as described above with reference to FIG. 2. Given that the spacing of micro spheres 18 in binder material layer 16 is not exactly equal, it is preferable to make the diameter of beam 30 be at least equal to the diameter D of the micro spheres. However, for writing an image one element at a time at the maximum resolution permitted by the micro sphere diameter (one element at a time) the beam diameter is preferably less than twice the nominal diameter of the micro sphere. This provides that the beam may be directed to any location on the laminate with a high (Q) probability of covering a micro sphere. Beam power can be adjusted such that any portion of the beam not intercepted by the micro sphere will not damage the reflective layer 20. Accordingly only that portion of the beam intercepted and concentrated by the micro sphere will form an image element 34.

Tilting mirror 40 directs the collimated beam through another portion of lens 42. In FIG. 3, mirror 40 is represented in a tilted position by dotted outline 40A. A correspondingly directed beam 30 is represented by dotted rays 32A. Lens 42 directs rays 32A to another micro sphere, here designated as micro sphere 18A, thereby forming another image element in reflective layer 20 of the laminate, designated in FIG. 3 as image element 34A. A multiple-element image is built up by directing the beam in an indexed fashion from one location on laminate 10 to another, delivering a laser radiation pulse at each location where an image element is desired.

It should be noted that because of a variation of the diameter and spacing of micro spheres about nominal values it is possible that for a beam having a diameter equal to the nominal diameter of the micro spheres, there is a finite possibility that a pulse may not provide a damaged area or may be intercepted by two spheres and produce two damaged areas. This has not been found to significantly degrade the quality of a written image.

It has been determined that any image comprising image elements 34 formed by the above-described method can be clearly seen only when viewed at about (for example within about ±3° of) the angle at which beam 30 was incident on the laminate when the image was formed. Referring again to FIG. 2, a beam 31 defined by rays 33 is indicated as incident at an angle θ on laminate 10. This forms an image element 34B in an off-center position in the corresponding reflective element 22. A beam 35 defined by rays 37 is indicated as incident at a different angle on laminate 10. This forms an image element 34C in a different off-center position in the corresponding reflective element 22. Accordingly, it is possible to provide two different images in reflective layer 20, one image viewable only at about one angle and the other image viewable only at about another angle. In such an arrangement, a reflective element 22 of layer 20 may include two spaced-apart image elements, one for each image, as indicated in FIG. 2 by image elements 34D and 34E. It should be noted here that the viewing angle sensitivity of images may be reduced if image elements have a diameter greater than fifty percent of the diameter of a reflective element 22.

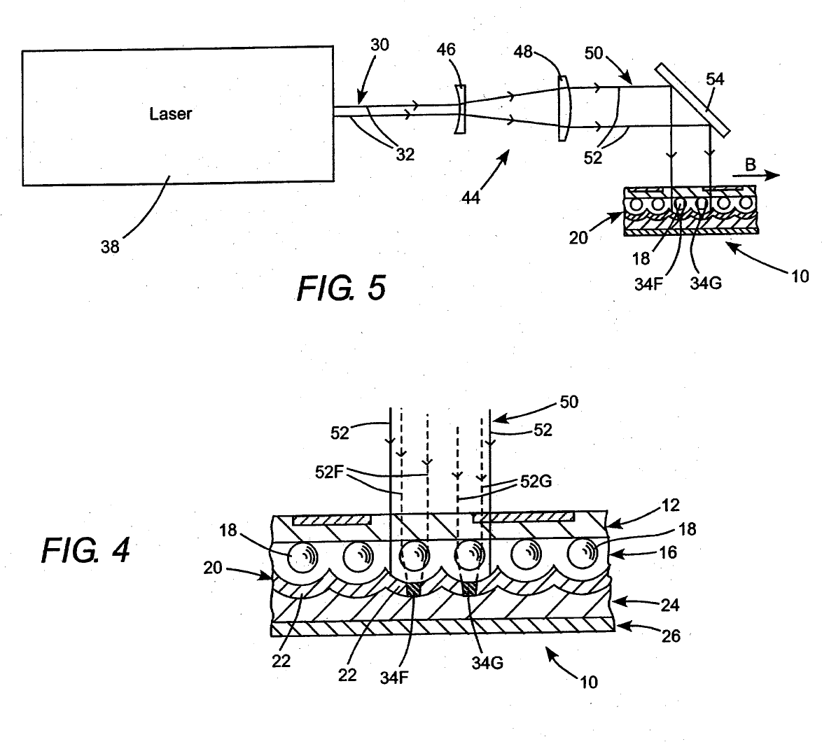

The method of the present invention is described above in the context of writing one image element at a time at the highest resolution permitted by laminate 10. If an image includes only large or wide features of uniform density, however, it is possible to write such an image more than one image element at a time. It is even possible to write an entire image using a single radiation pulse or exposure, for example by exposing the laminate through a mask. One embodiment of a multi-element writing arrangement in accordance with the present invention is described below with reference to FIG. 4 and FIG. 5.

Here, laser 38 delivers a collimated beam 30 to an afocal beam expander 44 including a negative optical element 46 and a positive optical element 48. Beam expander 44 delivers an expanded, collimated beam 50 (designated by rays 52) to a folding mirror 54. Folding mirror 54 directs beam 50 at normal incidence onto laminate 10. The diameter of the expanded beam is selected such that it sufficient to cover a predetermined plurality (here two) of micro spheres 18 at any location on the laminate. Power distribution across the beam is selected such that any that portion of the beam that is not intercepted and concentrated by micro spheres will not damage the reflective layer and form an image element. In FIG. 4, portions of beam 50 depicted by dotted rays 52F and 52G are concentrated to form image elements 34F and 34G, respectively. Moving beam 50 from one location to another on laminate 10 is accomplished in the arrangement of FIG. 5 by translating the laminate transverse to beam 50 as indicated by double arrow B.

While the method of the present invention is described above primarily with respect to using pulsed laser radiation, the use of continuous wave radiation (CW) radiation is not precluded. By way of example, in a case where only a single line or strip image is to be written in reflective layer 20, the laminate may be scanned continuously under a collimated CW beam in a manner similar to that depicted in FIG. 5. In this way, the dwell time of a micro sphere in the beam, being a function of the scan speed, the beam diameter, and the micro sphere diameter, determines the electromagnetic energy concentrated in the reflective layer. The beam diameter may be selected such that a feature is nominally only one image element wide or a plurality of elements wide. Different beam incidence angles may be selected as discussed above to provide images viewable at different angles. Whether image elements are formed one at a time or simultaneously, and whether there one image or more than one image, preferably, no concave reflective element 22 includes more than one element of any given image.

It is also possible to use non-laser radiation such as radiation from a high intensity discharge lamp. The light output from such a lamp, for example, can be collimated and concentrated by an afocal beam concentrator before being delivered to the laminate. From the detailed description presented herein, other variations of the method of the present invention may be evident to one skilled in the art without departing from the spirit and scope of the invention.

In summary, the present invention is described above as a preferred and other embodiments. Then invention is not limited, however, to the embodiments described and depicted herein. Rather the invention is limited only by the claims appended hereto.

What is claimed is:

1. A method of writing an image in a laminate, the image including an array of image elements, the laminate including a binder layer surmounting a reflective layer, and the binder layer including an array of micro spheres, the method comprising:
delivering a beam of electromagnetic radiation onto the laminate at a predetermined incidence angle therewith and at a position thereon such that the beam is concentrated by at least one of the micro spheres onto the reflective layer said radiation beam having a power sufficient that said reflective layer is damaged in an area thereof on which said radiation beam is concentrated, said damaged area forming one element of the image in the reflective layer.

2. The method of claim 1, wherein the beam of electromagnetic radiation is in the form of a pulse of laser radiation.

3. The method of claim 2, further including delivering another pulse of laser radiation onto the laminate at said predetermined incidence angle therewith and at another position thereon such that the beam is concentrated by another of the micro spheres onto the reflective layer said another pulse of laser radiation having a power sufficient that the reflective layer is damaged in an area thereof on which said another laser radiation pulse is concentrated, said damaged area forming another element of the image.

4. The method of claim 1, wherein said radiation beam has a diameter greater than the diameter of a said micro sphere.

5. The method of claim 4, wherein said radiation beam has a diameter less than twice the diameter of a said micro sphere and is concentrated by only said at least one micro sphere.

6. The method of claim 4, wherein said radiation beam has a diameter greater than twice the diameter of said micro sphere and portions of said radiation beam are concentrated by plurality of said micro spheres thereby forming a corresponding plurality of spaced-apart image elements in the reflective layer.

7. The method of claim 1, wherein said radiation beam is a collimated beam.

8. A product made by the process of claim 1.

9. A method of writing an image in a laminate, the image including an array of image elements, the laminate including a binder layer surmounting a reflective layer, and the binder layer including an array of micro spheres, the method comprising:
delivering a beam of electromagnetic radiation onto the laminate at a predetermined incidence angle and in a manner such that the beam is concentrated by a plurality of the micro spheres onto the reflective layer, said radiation beam having a power sufficient that the reflective layer is damaged in areas thereof on which said radiation beam is concentrated by the micro spheres, said damaged areas forming the image in said reflective layer.

10. The method of claim 9, wherein said radiation beam is delivered as a sequence of pulses and said radiation beam is moved from one position on the laminate to another between sequentially delivered ones of said pulses.

11. The method of claim 10, wherein said radiation beam has a diameter selected such that each one of said pulses is concentrated by only one micro sphere and forms only one image element.

12. The method of claim 10, wherein said radiation beam has a diameter selected such that each one of said pulses is concentrated by more than one micro sphere and forms more than one image element.

13. The method of claim 9, wherein said radiation beam is delivered as a beam of continuous wave radiation and the laminate is moved with respect to the beam during delivery of the radiation beam.

14. The method of claim 13, wherein said radiation beam has a diameter less than twice the diameter of a said micro sphere.

15. The method of claim 13, wherein said radiation beam has a diameter more than twice the diameter of a said micro sphere.

16. A product made by the process of claim 9.

17. A method of writing images in a laminate, each of the images including an array of image elements, the laminate including a binder layer surmounting a reflective layer, and the binder layer including an array of micro spheres, the method comprising:
delivering a beam of electromagnetic radiation onto the laminate at a first predetermined incidence angle therewith and in a manner such that the beam is concentrated by at least one micro sphere onto the reflective layer, said radiation beam having a power sufficient that the reflective layer is damaged in a first area thereof on which said radiation beam is concentrated by the micro sphere, said first damaged area forming a first image element in the reflective layer; and
delivering a beam of electromagnetic radiation onto the laminate at a second predetermined incidence angle therewith and in a manner such that the beam is concentrated by at least one micro sphere onto the reflective layer, said radiation beam having a power sufficient that the reflective layer is damaged in a second area thereof on which said radiation beam is concentrated by the micro sphere, said second damaged area forming a second image element in the reflective layer.

18. The method of claim 17, wherein said first and second damaged areas are of a size selected such that said first image element is visible only when said laminate is viewed at about said first incidence angle, and said second image element is visible only when said laminate is viewed at about said second incidence angle.

19. The method of claim 17, wherein said radiation beam is delivered as a sequence of pulses and said radiation beam is moved from one position on the laminate to another between sequentially delivered ones of said pulses.

20. The method of claim 19, wherein said radiation beam has a diameter selected such that each one of said pulses is concentrated by only one micro sphere and forms only one image element.

21. The method of claim 19, wherein said radiation beam has a diameter selected such that each one of said pulses is concentrated by more than one micro sphere and forms more than one image element.

22. The method of claim 17, wherein said radiation beam delivered as a beam of continuous wave radiation and the laminate is moved with respect to the beam during delivery of the radiation beam.

23. The method of claim 22, wherein said radiation beam has a diameter less than twice the diameter of a said micro sphere.

24. The method of claim 22, wherein said radiation beam has a diameter more than twice the diameter of a said micro sphere.

25. The method of claim 17, wherein the reflective layer is in the form of a plurality of concave reflective elements, each one thereof associated with an adjacent one of said micro spheres and wherein no one of said concave reflective elements is caused to include more than one image element of any one of said first and second images.

26. The method of claim 25, wherein any one of said concave reflectors is caused to include one image element from each of said first and second images.

27. A product made by the process of claim 17.

28. A laminated article; comprising;
a binder layer surmounting a reflective layer;
said binder layer including an array of micro spheres;
said reflective layer formed into a an array of concave reflective elements one thereof associated with each of said micro spheres;
a plurality of said concave reflective elements having non-reflective portions said non reflective portions of said reflective elements spaced apart from each other and forming elements of an image; and
wherein, said concave reflective elements, said non reflective portions of said reflective elements, and said micro spheres are arranged such that said image is viewable only at a predetermined viewing angle with respect to the laminated article.

29. The article of claim 28, wherein said concave reflective elements and said non reflective areas each has a diameter, and the diameter of said non-reflective areas is less than or equal to about 50% of the diameter of said concave reflective elements.

30. The article of claim 29, wherein, none of said concave reflective areas includes more than one element of said image.

31. The article of claim 28, wherein said non-reflective areas are formed by directing a beam of electromagnetic radiation onto a plurality of said micro spheres such that said radiation is concentrated onto said reflective layer thereby rendering said reflective layer non-reflective in the areas in which the radiation is concentrated.

32. A laminated article; comprising;
a binder layer surmounting a reflective layer;
said binder layer including an array of micro spheres;
said reflective layer formed into a an array of concave reflective elements one thereof associated with each of said micro spheres;
first and second pluralities of said concave reflective elements having non-reflective portions said non reflective portions of said reflective elements spaced apart from each other and forming elements of respectively first and second images; and
wherein, said concave reflective elements, said non reflective portions of said reflective elements, and said micro spheres are arranged such that said first image is viewable only at about a first a predetermined viewing angle with respect to the laminated article, and such that said second image is viewable only at about a second predetermined viewing angle with respect to the laminated article.

33. The article of claim 32, wherein said concave reflective elements and said non reflective areas each has a diameter, and the diameter of said non-reflective areas is less than or equal to about 50% of the diameter of said concave reflective elements.

34. The article of claim 33, wherein none of said concave reflective areas including more than one element of any of said first and second images.
